(19) United States
(12) Patent Application Publication
(10) Pub. No.: US 2019/0044199 A1
(43) Pub. Date: Feb. 7, 2019

(54) BATTERY MODULE AND APPLICATION OF SUCH A BATTERY MODULE

(71) Applicant: Robert Bosch GmbH, Stuttgart (DE)

(72) Inventor: Torsten Koller, Leinfelden-Echterdingen (DE)

(21) Appl. No.: 16/051,702

(22) Filed: Aug. 1, 2018

(30) Foreign Application Priority Data
Aug. 1, 2017 (DE) 10 2017 213 281.7

(51) Int. Cl. H01M 10/613; H01M 10/653; H01M 10/6554; H01M 10/625; H01M 2/02; H01M 10/0525

(52) U.S. Cl. CPC H01M 10/613; H01M 10/653; H01M 10/6554; H01M 2/1077; H01M 2/0277; H01M 10/0525; H01M 10/625

(57) ABSTRACT

A battery module comprising at least one battery cell (2), in particular a lithium-ion battery cell, and a cooling plate (3) which is connected to the at least one battery cell (2) in a thermally conductive manner, wherein a thermal equalization layer (4) is moreover arranged between the at least one battery cell (2) and the cooling plate (3), which is configured to increase thermal conductivity between the at least one battery cell (2) and the cooling plate (3), wherein the thermal equalization layer (4) is formed of a base material (5), and moreover comprises at least one polymer actuator (6), which has a transition temperature in excess of a temperature of 50° C.

### BACKGROUND OF THE INVENTION

The invention is based upon a battery module.

The invention further relates to the application of such a battery module.

From the prior art, it is known that battery modules can be comprised of a plurality of individual battery cells, which can be mutually interconnected in series and/or in parallel in an electrically conductive manner.

In particular, in electrically powered vehicles (EV), hybrid electric vehicles (HEV) or plug-in hybrid electric vehicles (PHEV), battery modules comprising energy-dense and high-capacity lithium-ion battery cells or lithium-polymer battery cells, preferably comprised of the order of one hundred battery cells, are employed in order to permit the fulfillment of increased expectations with respect to driving performance.

As a result of chemical conversion processes, lithium-ion battery cells or lithium-polymer battery cells undergo heat-up, in particular during the release and take-up of electrical energy, such that, for the operation of high-performance battery cells of this type within a preferred temperature range, it is further known that battery modules can incorporate a temperature-control system, which in particular is intended to ensure that the battery cells do not exceed a predefined temperature.

It should be observed that the preferred temperature range for lithium-ion battery cells lies between the order of 5° C. and 35° C. Moreover, the service life thereof declines continuously with effect from a service temperature of the order of approximately 40° C., as a result of which, in the interests of the fulfillment of requirements for a satisfactory service life, the battery cells should be maintained in a non-critical thermal state, below 40° C., by means of the temperature-control system. Moreover, the temperature difference between the different battery cells should not exceed 5 degrees Kelvin.

To this end, temperature-control systems employing, for example, fluids such as, for example, water/glycol mixtures, flowing through cooling plates, are known from the prior art.

The arrangement of a thermal equalization layer, described as a “Thermal Interface Material” (TIM), between such cooling plates and the battery cells of the battery module is also known from the prior art.

Conversely, if the battery cells exceed a predefined safety-critical temperature, this can result in the thermal runaway of the battery cell, with a possibly associated risk of propagation, thereby resulting in substantial safety risks.

### SUMMARY OF THE INVENTION

A battery module provides an advantage, in that protection against propagation in the event of the thermal runaway of a battery cell can be provided in a reliable manner.

To this end, a battery module is provided, comprising at least one battery cell and a cooling plate.

The battery cell is in particular a lithium-ion battery cell.

Moreover, the cooling plate is connected to the at least one battery cell in a thermally conductive manner.

Between the at least one battery cell and the cooling plate, a thermal equalization layer is moreover arranged, which is configured to increase thermal conductivity between the at least one battery cell and the cooling plate.

The thermal equalization layer is formed of a base material, and moreover comprises at least one polymer actuator.

The at least one polymer actuator has a transition temperature in excess of a temperature of 50° C.

Preferably, the at least one polymer actuator has a transition temperature in excess of a temperature of 65° C.

In particular, the at least one polymer actuator has a transition temperature in excess of a temperature of 80° C.

By means of the measures described in the dependent claims, advantageous further developments and improvements of the device disclosed in the independent claim are possible.

In particular, in battery cells having a temperature in excess of 80° C., reference is made to the thermal runaway of the respective battery cell. In this case, for example, internal short-circuits can result in a rapid increase in the cell temperature, as a result of which further exothermic reactions can be accelerated, to the extent that the respective battery cell may even be susceptible to explosion.

In this regard, propagation protection is therefore to be understood, firstly, as the prevention of the further heat-up of a battery cell which has exceeded a specific safety-critical temperature.

The transition of this battery cell to a non-critical state can thus be achieved, and the runaway of said battery cell can be prevented.

The direct or indirect heat-up of a battery cell by a battery cell which assumes a safety-critical state is described as thermal propagation, and is likewise associated with a high safety-related risk.

In this regard, propagation protection is therefore to be understood, secondly, as the prevention of any heat-up of a battery cell which is arranged adjacently to a battery cell which has a specific safety-critical exceeded temperature.

In a form of embodiment of the battery module according to the invention, in the event of thermal runaway of the at least one battery cell, the optimized thermal conduction path between the at least one battery cell and the cooling plate, through the thermal equalization layer, which path is in particular employed for the cooling of the at least one battery cell, can be interrupted, thereby preventing any further thermal conduction via the cooling plate.

Overall, it is thus possible to provide a thermal equalization layer having an integrated propagation protection element.

At this point, it should be observed that a polymer actuator is to be understood as an element which, in response to a variation in the ambient temperature, can repeatedly execute a change into and out of different shapes.

A change of this type thus occurs in response to an overshoot or undershoot of the “transition temperature”.

The different shapes in particular describe an expansion or contraction of the material of the polymer actuator, or a deformation, for example a bending, of the material of the polymer actuator.

In particular, the temperature and the direction into or out of which a change is executed can be defined, and can be set as required.

In particular, such a change into and out of different shapes can be configured as a reversible process.

A polymer actuator can be configured, for example, from copolymer networks of oligo(e-caprolactones) and n-butyl acrylates.

It is advantageous if the base material of the thermal equalization layer is constituted of an electrically insulating material.

As a result, it is possible to configure a defined electrical insulation between the at least one battery cell and the cooling plate.

Moreover, the base material of the thermal equalization layer can be selected such that, additionally, adequate thermal conductivity can be configured between the at least one battery cell and the cooling plate.

In particular, the base material of the thermal equalization layer can be configured for example from a polymer material, or in the form of a semi-solid or high-viscosity material.

It is appropriate if the base material of the thermal equalization layer is elastically and/or plastically deformable.

In particular, the base material can be reversibly deformable.

It is thus possible, during the operation of the battery module, to offset inconsistencies in the arrangement of the at least one battery cell relative to the cooling plate.

According to an advantageous aspect of the invention, the polymer actuator is arranged within the base material of the thermal equalization layer. This has an advantage in that, in the event of an overshoot of the transition temperature of the at least one polymer actuator, which preferably lies below the safety-critical temperature of the at least one battery cell, the at least one polymer actuator changes shape, and preferably expands, as a result of which a clearance between the at least one battery cell and the cooling plate can be increased.

Accordingly, an air-filled gap can preferably also be configured between the at least one battery cell and the cooling plate, as a result of which the thermal conductivity between the at least one battery cell and the cooling plate, in comparison with the base material, is comparatively substantially reduced.

In particular, given that air, at 0.026 Watts per meter per degree Kelvin, has a relatively low thermal conductivity, a localized thermal insulating layer with a high thermal resistance can be constituted.

It is advantageous if the at least one polymer actuator is arranged between the at least one battery cell and the base material and/or if the at least one polymer actuator is arranged between the cooling plate and the base material.

This has an advantage in that, in the event of an overshoot of the transition temperature of the at least one polymer actuator, which preferably lies below the safety-critical temperature of the at least one battery cell, the at least one polymer actuator changes shape, and preferably expands, as a result of which a clearance between the at least one battery cell and the cooling plate can be increased.

Accordingly, an air-filled gap can preferably also be configured between the at least one battery cell and the cooling plate, as a result of which the thermal conductivity between the at least one battery cell and the cooling plate, in comparison with the base material, is comparatively substantially reduced. In particular, given that air, at 0.026 Watts per meter per degree Kelvin, has a relatively low thermal conductivity, a localized thermal insulating layer with a high thermal resistance can be constituted.

According to a preferred form of embodiment, the thermal equalization layer comprises a plurality of polymer actuators.

More reliable propagation protection can be provided accordingly.

According to an appropriate aspect of the invention, the at least one polymer actuator is configured such that the at least one polymer actuator, above the transition temperature, assumes a first shape and, below the transition temperature, assumes a second shape.

In particular, the first shape differs from the second shape. In particular, the first shape assumes a volume which is double the volume of the second shape.

It is thus possible, in the event of an overshoot of the safety-critical temperature of the at least one battery cell, to reliably provide propagation protection.

In this regard, it should also be observed overall that, in a battery module according to the invention, both sufficient thermal conductivity between the at least one battery cell and the cooling plate and reliable propagation protection can be provided.

It should further be observed that, further to the thermal runaway of the at least one battery cell and the change in the at least one polymer actuator, upon renewed undershoot of the transition temperature, the at least one polymer actuator can be restored to its original shape, and the process is thus configured in a reversible manner.

The invention further relates to the application of a battery module according to the invention for the prevention of the transmission of heat from the at least one battery cell to the cooling plate, in particular in the event of an overshoot of a safety-critical temperature.

A battery module according to the invention can be employed, both for batteries in electric vehicles, hybrid vehicles and plug-in hybrid vehicles, and for portable consumer electronics and communication devices, and can also be employed in stationary stores and stores for medical purposes including, for example, intracorporeal batteries.

### BRIEF DESCRIPTION OF THE DRAWINGS

Exemplary embodiments of the invention are represented in the drawings, and are described in greater detail in the following description.

In the drawings:

FIG. 1 shows a schematic representation of one form of embodiment of a battery module according to the invention, having a polymer actuator, and

FIG. 2 shows a schematic representation of a further form of embodiment of a battery module according to the invention, having a polymer actuator.

### DETAILED DESCRIPTION

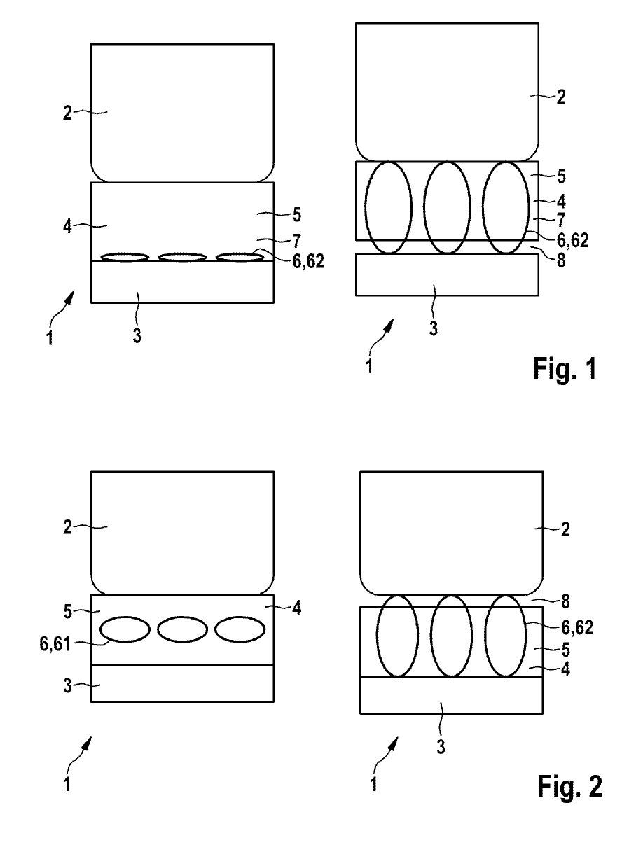

FIG. 1 shows a schematic representation of one form of embodiment of a battery module 1.

The battery module 1 comprises at least one battery cell 2, which is in particular a lithium-ion battery cell.

The battery module 1 further comprises a cooling plate 3.

The cooling plate 3 is connected to the at least one battery cell 2 in a thermally conductive manner.

In order to increase thermal conductivity between the at least one battery cell 2 and the cooling plate 3, a thermal equalization layer 4 is arranged between the at least one battery cell 2 and the cooling plate 3.

The thermal equalization layer 4 is constituted of a base material 5. The base material 5 of the thermal equalization layer 4 is preferably constituted of an electrically insulating material 7. For example, the base material can be constituted of a silicone or an epoxide, and can additionally incorporate further thermally conductive filler materials. Moreover, the base material can be constituted of a polymer and/or of a semi-solid or high-viscosity material.

Moreover, the base material 5 of the thermal equalization layer 4 is preferably configured as an elastically and/or plastically deformable material.

The thermal equalization layer 4 further comprises a polymer actuator 6.

The polymer actuator 6 has a transition temperature in excess of a temperature of 50° C.

Preferably, the polymer actuator 6 has a transition temperature in excess of a temperature of 65° C.

In particular, the polymer actuator 6 has a transition temperature in excess of a temperature of 80° C.

In particular, the thermal equalization layer 4 can comprise a plurality of polymer actuators 6.

The polymer actuator 6 is configured such that, above the transition temperature, it assumes a first shape 61 and, below the transition temperature, assumes a second shape 62.

The right-hand representation in FIG. 1 shows a state of the polymer actuator 6, in which the latter is configured with a first shape 61, and the left-hand representation in FIG. 1 shows a state of the polymer actuator 6, in which the latter is configured with a second shape 62.

In particular, from a comparison of the right-hand representation in FIG. 1 with the left-hand representation in FIG. 1, it will be seen that the volume of the first shape 61 is at least double the volume of the second shape 62.

In particular, the left-hand representation thus shows a state in which the temperature lies below the transition temperature, and the right-hand representation shows a state in which the temperature lies above the transition temperature.

FIG. 1 represents a form of embodiment of the battery module 1, in which the at least one polymer actuator 6 is arranged between the cooling plate 3 and the base material 5 of the thermal equalization layer 4.

Naturally, it is also possible that the at least one polymer actuator 6 is arranged between the at least one battery cell 2 and the base material 5 of the thermal equalization layer 4.

FIG. 2 represents a further form of embodiment of a battery module 1 according to the invention.

The battery module 1 represented in FIG. 2 only differs, in that the at least one polymer actuator 6 is arranged within the base material 5 of the thermal equalization layer 4.

From FIGS. 1 and 2, it can further be seen that, in the event of an overshoot of the transition temperature of the at least one polymer actuator 6, and with the arrangement of the at least one polymer actuator 6 in the second shape 62, an air gap 8 can be configured.

The air gap 8 can constitute a thermally insulating layer between the at least one battery cell 2 and the cooling plate 3.

1. A battery module, comprising
at least one battery cell (2),
a cooling plate (3) which is connected to the at least one battery cell (2) in a thermally conductive manner, and
a thermal equalization layer (4) arranged between the at least one battery cell (2) and the cooling plate (3),
wherein the thermal equalization layer is configured to increase thermal conductivity between the at least one battery cell (2) and the cooling plate (3), formed of a base material (5), and comprises at least one polymer actuator (6), which has a transition temperature in excess of a temperature of 50° C.

2. The battery module according to claim 1, wherein the base material (5) of the thermal equalization layer (4) is constituted of an electrically insulating material (7).

3. The battery module according to claim 1, wherein the base material (5) of the thermal equalization layer (4) is elastically and/or plastically deformable.

4. The battery module according to claim 1, wherein the at least one polymer actuator (6) is arranged within the base material (5).

5. The battery module according to claim 1, wherein the at least one polymer actuator (6) is arranged between the at least one battery cell (2) and the base material (5) and/or in that the at least one polymer actuator (6) is arranged between the cooling plate (3) and the base material (5).

6. The battery module according to claim 1, wherein the thermal equalization layer (4) comprises a plurality of polymer actuators (6).

7. The battery module according to claim 1, wherein the at least one polymer actuator (6) is configured such that the at least one polymer actuator (6), above the transition temperature, assumes a first shape (61) and, below the transition temperature, assumes a second shape (62), wherein the first shape (61) differs from the second shape (62).

8. The battery module according to claim 7, wherein a transmission of heat from the at least one battery cell (2) to the cooling plate (3) is prevented.
